(19) United States
(12) Patent Application Publication
(10) Pub. No.: US 2023/0150317 A1
(43) Pub. Date: May 18, 2023

(54) Tire Pressure Monitoring System Learning Method, Device, Sensor, System and Medium

(71) Applicant: SHENZHEN XTOOLTECH INTELLIGENT CO., LTD., Shenzhen, Guangdong (CN)

(72) Inventors: Jian Chen, Shenzhen, Guangdong (CN); Xianping Yang, Shenzhen, Guangdong (CN); Kai Wu, Shenzhen, Guangdong (CN); Xiangyu Jin, Shenzhen, Guangdong (CN); Yanjian Huan, Shenzhen, Guangdong (CN)

(21) Appl. No.: 17/641,815

(22) PCT Filed: May 31, 2021
(86) PCT No.: PCT/CN2021/097150

§ 371 Date: Mar. 9, 2022

(30) Foreign Application Priority Data
Oct. 16, 2020 (CN) 202011111040.5

(51) Int. Cl. B60C 23/04; G01L 17/00; G06N 20/00

(52) U.S. Cl. CPC B60C 23/0474; G01L 17/00; G06N 20/00; B60C 23/0481

(57) ABSTRACT

Provided is a tire pressure monitoring system learning method, device, sensor, system and medium. The tire pressure monitoring system learning method comprises following steps: receiving low-frequency data sent by a low-frequency trigger equipment; determining a command type corresponding to the low-frequency data; acquiring a preset tire pressure data in the low-frequency data if the command type is a sending command of custom high-frequency data, wherein the preset tire pressure data is used for simulating data sent by the tire pressure sensor to a vehicle-mounted ECU in a preset learning scene; generating high-frequency data based on a pre-stored high-frequency configuration parameter and the preset tire pressure data, and sending the high-frequency data to the vehicle-mounted ECU. The technical solution of the application enables the tire pressure sensor to send high-frequency data which can be identified by different vehicle-mounted ECUs, thus improving the adaptability of the tire pressure sensor.

The present application is based on and claims the benefit of Chinese Patent Application No. 202011111040.5, titled “Tire pressure monitoring system learning method, device, sensor, system and medium”, and filed on Oct. 16, 2020.

### TECHNICAL FIELD

The present application relates to the field of automobiles, in particular to tire pressure monitoring system learning method, device, sensor, system and medium.

### BACKGROUND

Tire pressure monitoring system (TPMS) is a system that can automatically monitor various conditions of tires in real time by recording tire rotation speed or the tire pressure sensors installed in tires. Tire pressure monitoring system includes Direct Tire Pressure Monitoring System (Pressure-Sensor Based TPMS, referred to as PSB), the Direct Tire Pressure Monitoring System PSB is generally used together with vehicle-mounted Electronic Control Unit (referred to as ECU).

The vehicle-mounted ECU stores the ID of tire pressure sensor in each tire of the current vehicle. When one or more tire pressure sensors are replaced, the vehicle-mounted ECU needs to re-identify the tire pressure sensor. However, the identification of tire pressure sensors in tires by vehicle-mounted ECU usually needs a learning process. When the tire pressure sensors are triggered by low-frequency signals, one kind of tire pressure sensor (such as original) can only send a specific high-frequency data, which can only be identified by a specific vehicle type. Once the tire pressure sensor is replaced with another type (such as non-original) of tire pressure sensor, the vehicle-mounted ECU of the current vehicle type cannot smoothly recognize the tire pressure sensor.

### SUMMARY

The embodiments of the present application provide a learning method, a tire pressure monitoring system learning method, device, sensor, system and medium, aiming at solving the problem that the tire pressure sensor cannot send high-frequency data which meet learning requirements of different vehicle ECUs.

A tire pressure monitoring system learning method, including following steps executed by a tire pressure sensor:

receiving low-frequency data sent by a low-frequency trigger equipment;

determining a command type corresponding to the low-frequency data;

acquiring a preset tire pressure data in the low-frequency data if the command type is a sending command of custom high-frequency data, wherein the preset tire pressure data is used for simulating data sent by the tire pressure sensor to a vehicle-mounted ECU in a preset learning scene;

generating high-frequency data based on a pre-stored high-frequency configuration parameter and the preset tire pressure data, and sending the high-frequency data to the vehicle-mounted ECU.

Further, the step of determining a command type corresponding to the low-frequency data includes:

analyzing the low-frequency data to obtain a command type identifier contained in the low-frequency data;

determining a command type corresponding to the low-frequency data based on the command type identifier.

Further, after determining a command type corresponding to the low-frequency data, the tire pressure monitoring system learning method further includes:

obtaining a high-frequency configuration parameter in the low-frequency data if the command type is a setting command of high-frequency parameters;

performing high-frequency configuration on the tire pressure sensor based on the high-frequency configuration parameter, and storing the high-frequency configuration parameter.

Further, after performing high-frequency configuration on the tire pressure sensor based on the high-frequency configuration parameter, and storing the high-frequency configuration parameter, the tire pressure monitoring system learning method further includes:

sending a first response information to the low-frequency trigger equipment, wherein the first response information is used to indicate that the high-frequency configuration parameter is successfully configured.

Further, after generating high-frequency data based on a pre-stored high-frequency configuration parameter and the preset tire pressure data, and sending the high-frequency data to the vehicle-mounted ECU, the tire pressure monitoring system learning method further includes:

returning a second response information to the low-frequency trigger equipment, wherein the second response information is used to indicate that the high-frequency data is successfully sent.

Further, prior to determining a command type corresponding to the low-frequency data, the tire pressure monitoring system learning method further includes:

verifying the low-frequency data to obtain a verification result;

determining a command type corresponding to the low-frequency data if the verification result is passed.

Further, the step of verifying the low-frequency data to obtain a verification result includes: performing XOR operation on the low-frequency data to obtain an actual verification value; extracting a configured verification value from the low-frequency data, and comparing the actual verification value with the configured verification value;

determining the verification result is passed if the actual verification value is same as the configured verification value.

A tire pressure monitoring system learning device, includes:

a low-frequency data receiving module, configured to receive low-frequency data sent by a low-frequency trigger equipment;

a command type determination module, configured to determine a command type corresponding to the low-frequency data based on the command type identifier.

a tire pressure data acquisition module, configured to acquire a preset tire pressure data in the low-frequency data if the command type is a sending command of custom high-frequency data, wherein the preset tire pressure data is used for simulating data sent by the tire pressure sensor to a vehicle-mounted ECU in a preset learning scene;

a high-frequency data sending module, configured to generate high-frequency data based on a pre-stored high-frequency configuration parameter and the preset tire pressure data, and send the high-frequency data to the vehicle-mounted ECU.

Further, the command type determination module includes: a data analysis submodule, configured to analyze the low-frequency data to obtain a command type identifier contained in the low-frequency data;

a type identification submodule, configured to determine a command type corresponding to the low-frequency data based on the command type identifier.

Further, the tire pressure monitoring system learning device includes:

a configuration parameter acquisition module, configured to obtain a high-frequency configuration parameter in the low-frequency data if the command type is a setting command of high-frequency parameters;

a high-frequency configuration module, configured to perform high-frequency configuration on the tire pressure sensor based on the high-frequency configuration parameter, and store the high-frequency configuration parameter.

Further, the tire pressure monitoring system learning device includes:

a configuration success module, configured to send a first response information to the low-frequency trigger equipment, wherein the first response information is used to indicate that the high-frequency configuration parameter is successfully configured.

Further, the tire pressure monitoring system learning device includes:

a sending success module, configured to return a second response information to the low-frequency trigger equipment, wherein the second response information is used to indicate that the high-frequency data is successfully sent.

Further, the tire pressure monitoring system learning device includes:

a data verification module, configured to verify the low-frequency data to obtain a verification result;

a verification pass module, configured to determine a command type corresponding to the low-frequency data if the verification result is passed.

Further, the data verification module includes:

an XOR submodule, configured to perform XOR operation on the low-frequency data to obtain an actual verification value;

a verification value extraction submodule, configured to extract a configured verification value from the low-frequency data, and compare the actual verification value with the configured verification value;

a verification result submodule, configured to determine the verification result is passed if the actual verification value is same as the configured verification value.

A tire pressure sensor, including a memory, a processor and a tire pressure sensing program stored in the memory and executable on the processor, when the processor executes the tire pressure sensing program, the tire pressure monitoring system learning method is realized.

A tire pressure monitoring system, including: a low-frequency trigger equipment, a vehicle-mounted ECU and the above-described tire pressure sensor.

A computer-readable storage medium, storing a tire pressure sensing program, wherein the tire pressure sensing program, when executed by a processor, realizes the above-described tire pressure monitoring system learning method.

According to the above-described tire pressure monitoring system learning method, device, sensor, system and medium, the following steps are realized: receiving low-frequency data sent from a low-frequency trigger equipment by a tire pressure sensor; determining a command type corresponding to the low-frequency data; acquiring a preset tire pressure data in the low-frequency data if the command type is a sending command of custom high-frequency data; generating high-frequency data based on a pre-stored high-frequency configuration parameter and the preset tire pressure data, and sending the high-frequency data to the vehicle-mounted ECU. In this way, the tire pressure sensor can send high-frequency data that can be recognized by different vehicle-mounted ECUs, thus improving the adaptability of the tire pressure sensor.

### BRIEF DESCRIPTION OF DRAWINGS

In order to explain the technical solution of the embodiments of the present application more clearly, the drawings used in the description of the embodiments of the application will be briefly introduced below. Obviously, the drawings in the following description show only some embodiments of the application, and for those of ordinary skill in the field, other drawings may be obtained according to these drawings without any creative effort.

FIG. 1 is a flowchart of a tire pressure monitoring system learning method according to an embodiment of the present application;

FIG. 2 is another flowchart of a tire pressure monitoring system learning method according to an embodiment of the present application;

FIG. 3 is another flowchart of a tire pressure monitoring system learning method according to an embodiment of the present application;

FIG. 4 is another flowchart of a tire pressure monitoring system learning method according to an embodiment of the present application;

FIG. 5 is another flowchart of a tire pressure monitoring system learning method according to an embodiment of the present application;

FIG. 6 is a schematic diagram of a tire pressure monitoring system learning device according to an embodiment of the present application;

FIG. 7 is a schematic diagram of a tire pressure sensor according to an embodiment of the present application;

FIG. 8 is a schematic diagram of a tire pressure monitoring system according to an embodiment of the present application.

### DETAILED DESCRIPTION OF THE DISCLOSED EMBODIMENTS

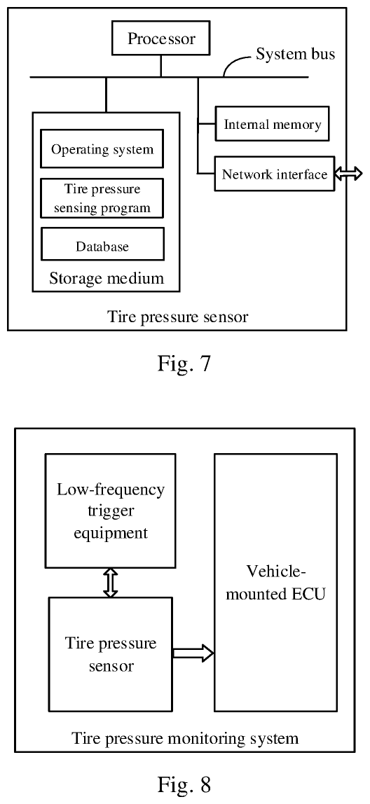

The technical solution in the embodiments of the present application will be described clearly and completely with reference to the drawings in the embodiments of the application. Obviously, the described embodiments are part of the embodiments of the application, not all of them. Based on the embodiments in the present application, all other embodiments obtained by those skilled in the art without creative effort fall in the protection scope of the application. The embodiments of the present application provide a tire pressure monitoring system learning method, which may be applied to the tire pressure sensor shown in FIG. 7. The following steps are realized: receiving low-frequency data sent from a low-frequency trigger equipment by a tire pressure sensor; determining a command type corresponding to the low-frequency data; acquiring a preset tire pressure data in the low-frequency data if the command type is a sending command of custom high-frequency data; generating high-frequency data based on a pre-stored high-frequency configuration parameter and the preset tire pressure data, and sending the high-frequency data to the vehicle-mounted ECU. In this way, the tire pressure sensor can send high-frequency data that can be recognized by different vehicle-mounted ECUs, thus improving the adaptability of the tire pressure sensor.

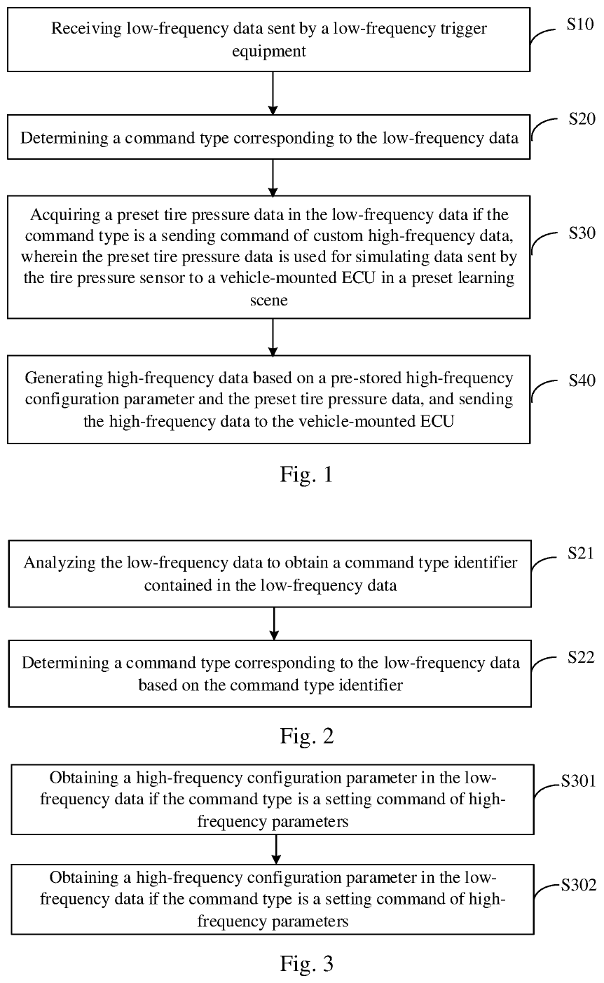

In an embodiment, as shown in FIG. 1, a tire pressure monitoring system learning method is provided, which is illustrated by taking the application of this method to the tire pressure sensor as an example. The method includes the following steps:

S10: receiving low-frequency data sent by a low-frequency trigger equipment.

In which, the low-frequency trigger equipment may be an equipment capable of transmitting low-frequency data with a frequency of 125Khz. The low-frequency data may be data with frequency of 125 Khz, which is used to trigger and wake up the tire pressure sensor. The low-frequency data includes user-defined settings: a setting command of high-frequency parameters; and a sending command of custom high-frequency data. In which, the setting command of high-frequency parameters is a command for instructing the tire pressure sensor to perform high-frequency configuration. The sending command of custom high-frequency data is a command for instructing the tire pressure sensor to send a preset tire pressure data to a vehicle-mounted ECU according to a pre-stored high-frequency configuration parameter. The pre-stored high-frequency configuration parameter is a high-frequency configuration set by the tire pressure sensor according to the setting command of high-frequency parameters. The preset tire pressure data is the data that can be recognized by the vehicle-mounted ECU according to the pre-configuration of the vehicle type, which is used to simulate the state data sent by the tire pressure sensor in different scenes. For example, it simulates the state data corresponding to the activation of the tire pressure sensor by the low-frequency trigger equipment, tire deflation or vehicle running, and modulated to the sending command of custom high-frequency data. The preset tire pressure data may include the identity information of the tire pressure sensor, such as ID. The identity information is obtained by activating the tire pressure sensor by outputting a low-frequency signal from the low-frequency trigger equipment and receiving the identity information returned by the activated tire pressure sensor. Understandably, the tire pressure sensor may configure different high-frequency configurations according to different setting commands of high-frequency parameters, and acquire different preset tire pressure data according to different sending commands of custom high-frequency data, so that the tire pressure sensor can send different high-frequency data to adapt to different types of vehicle-mounted ECU.

S20: determining a command type corresponding to the low-frequency data.

The command type is the type corresponding to user-set command in the low-frequency data. The command type corresponding to the low-frequency data includes, but is not limited to, a setting command of high-frequency parameters and a sending command of custom high-frequency data.

As an example, since the low-frequency data includes a setting command of high-frequency parameters and a sending command of custom high-frequency data, it is necessary to determine whether the command type corresponding to the low-frequency data sent by the low-frequency trigger equipment is a setting command of high-frequency parameters or a sending command of custom high-frequency data to execute the corresponding command.

Further, the manner in which the tire pressure sensor determines the command type corresponding to the low-frequency data may be: acquiring a command type identifier contained in the low-frequency data, and determining the command type corresponding to the low-frequency data based on the command type identifier. The command type identifier is the identifier corresponding to the command in the low-frequency data. As an example, when the value corresponding to the command type identifier CMD is 0xB1, it is determined that the command type corresponding to the low-frequency data is a setting command of high-frequency parameters. When the value corresponding to the command type identifier CMD is 0xB2, it is determined that the command type corresponding to the low-frequency data is a sending command of custom high-frequency data.

S30: acquiring a preset tire pressure data in the low-frequency data if the command type is a sending command of custom high-frequency data, and the preset tire pressure data is used for simulating data sent by the tire pressure sensor to a vehicle-mounted ECU in a preset learning scene.

Specifically, the preset tire pressure data is the data preset by the user, which is used to simulate the data sent by the tire pressure sensor to the vehicle-mounted ECU in the preset learning scene, and is modulated into the sending command of custom high-frequency data. For example, the preset learning scene includes, but is not limited to, simulating the state data corresponding to the activation of the tire pressure sensor by the low-frequency trigger equipment, tire deflation and vehicle running. Understandably, the tire pressure sensor may configure different high-frequency configurations according to different setting commands of high-frequency parameters, and acquire different preset tire pressure data according to different sending commands of custom high-frequency data, so that the tire pressure sensor can send different high-frequency data to adapt to different types of vehicle-mounted ECU.

As an example, when the command type is a sending command of custom high-frequency data, acquiring preset tire pressure data in the low-frequency data, and the preset tire pressure data is the data when the simulated tire pressure sensor is activated by the low-frequency trigger equipment.

S40: generating high-frequency data based on a pre-stored high-frequency configuration parameter and the preset tire pressure data, and sending the high-frequency data to the vehicle-mounted ECU.

In which, the pre-stored high-frequency configuration parameter includes, but is not limited to, a high-frequency point and a high-frequency modulation mode. The high-frequency point is frequency point of high-frequency data. The high-frequency modulation mode is the process of loading tire pressure data into high-frequency data, including at least one modulation mode of amplitude modulation, frequency modulation and phase modulation.

As an example, when the command type is a sending command of custom high-frequency data, analyzing the sending command of custom high-frequency data to obtain Len+CMD+Data (n bytes)+XOR, and acquiring preset tire pressure data Data (n bytes). Here, Len is the complete frame data length of the high-frequency parameter command, including Len itself; CMD is the command type identifier, when it is 0B2, the command type of low-frequency data is sending command of custom high-frequency data; Data is preset tire pressure Data, which is composed of NRZ (Non-return-to-zero, NRZ for short) code; XOR: is the verification field of the complete frame data of the sending command of custom high-frequency data, which is used to verify whether the setting of the sending command of custom high-frequency data is abnormal or not. NRZ is non-return-to-zero code, i.e. positive represents indicates 1 and low represents indicates 0. It can form any coding format, a data frame coding format of high-frequency data is not required. It can enable different types of vehicle ECU to identify and improve the adaptability of vehicle ECU in identifying high-frequency data.

As an example, optionally, the high-frequency point of the high-frequency configuration parameter may be 315 Mhz, 315.12 Mhz or 314.87 Mhz, or 433 Mhz or 433.92 Mhz. For example, the tire pressure sensor adopts 315 Mhz as the high frequency point in the pre-stored high frequency configuration parameter and quadrature amplitude modulation as the high-frequency modulation mode. That is, the combination of amplitude modulation and phase modulation. The preset tire pressure data is modulated to high-frequency data, and the high-frequency data is sent to the vehicle-mounted ECU.

In this embodiment, the following steps are realized: receiving low-frequency data sent from a low-frequency trigger equipment by a tire pressure sensor; determining a command type corresponding to the low-frequency data; acquiring a preset tire pressure data in the low-frequency data if the command type is a sending command of custom high-frequency data; generating high-frequency data based on a pre-stored high-frequency configuration parameter and the preset tire pressure data, and sending the high-frequency data to the vehicle-mounted ECU. In this way, the tire pressure sensor can send high-frequency data that can be recognized by different vehicle-mounted ECUs, thus improving the adaptability of the tire pressure sensor.

In an embodiment, as shown in FIG. 2, in step S20, determining a command type corresponding to the low-frequency data includes:

S21: analyzing the low-frequency data to obtain a command type identifier contained in the low-frequency data.

Specifically, the tire pressure sensor analyzes the low-frequency data, reads the field corresponding to the command type identifier in the low-frequency data, and obtains the command type identifier based on the field corresponding to the command type identifier. As an example, in an application scenario, the tire pressure sensor analyzes the low-frequency data to obtain Len+CMD+BitWidth+PLLCR_0+PLLCR_1+PLLCR_2+PLLCR_3+count+XOR, reads the field corresponding to the command type identifier CMD, and obtains the value corresponding to the command type identifier CMD, which is 0xB1.

Here, Len is the complete frame data length of the high-frequency parameter command, including Len itself; CMD is CMD command, when it is 0xB1, representing the command type corresponding to low-frequency data is setting command of high-frequency parameters; BitWidth is the bit width of data transmission; PLLCR_0-PLLCR_3 is the high-frequency point and high-frequency modulation mode for configuring high-frequency data; Count: the number of frames of high-frequency data to be sent by the tire pressure sensor, in order to avoid that the vehicle-mounted ECU cannot receive high-frequency data, a plurality of frames of high-frequency data to be sent are set to ensure that the vehicle-mounted ECU can receive high-frequency data; XOR: is the verification field of the complete frame data of setting command of high-frequency parameters, which is used to verify whether the setting command of high-frequency parameters is abnormal.

S22: determining a command type corresponding to the low-frequency data based on the command type identifier.

As an example, when the value corresponding to the command type identifier CMD is 0xB1, it is determined that the command type corresponding to the low-frequency data is a setting command of high-frequency parameters. When the value corresponding to the command type identifier CMD is 0B2, it is determined that the command type corresponding to the low-frequency data is a sending command of custom high-frequency data.

In this embodiment, the tire pressure sensor analyzes the low-frequency data to obtain the command type identifier contained in the low-frequency data. Based on the command type identifier, the command type corresponding to the low-frequency data is determined, so that the tire pressure sensor can execute the command corresponding to the command type identifier according to the command type identifier. The corresponding command is identified according to the command type identifier, high-frequency data which can be identified by different types of vehicle-mounted ECU are satisfied, and the adaptability of the tire pressure sensor is improved.

In an embodiment, as shown in FIG. 3, after step S30, i.e., after determining a command type corresponding to the low-frequency data, the tire pressure monitoring system learning method further includes:

S301: obtaining a high-frequency configuration parameter in the low-frequency data if the command type is a setting command of high-frequency parameters.

S302: performing high-frequency configuration on the tire pressure sensor based on the high-frequency configuration parameter, and storing the high-frequency configuration parameter.

As an example, if the command type is a setting command of high-frequency parametersLen+CMD+B itWidth+PLLCR_0+PLLCR_1+PLLCR_2+PLLCR_3+count+XOR, acquiring high-frequency configuration parameter in low-frequency data, PLLCR_0, PLLCR_1, PLLCR_2 and PLLCR_3, PLLCR_0−PLLCR_3 is the high-frequency point and high-frequency modulation mode for configuring high-frequency data. Determine the pre-stored high-frequency configuration parameter to be PLLCR_0, PLLCR_1, PLLCR_2, and PLLCR_3, and store the high-frequency configuration parameter PLLCR_0, PLLCR_1, PLLCR_2, and PLLCR_3. Understandably, users can set different high-frequency configuration parameters according to actual needs, so that the tire pressure sensor can send different high-frequency data to meet the high-frequency data required by different types of vehicle-mounted ECU.

In this embodiment, if the command type is a setting command of high-frequency parameters, the tire pressure sensor acquires the high-frequency configuration parameter in the low-frequency data, performs high-frequency configuration based on the high-frequency configuration parameter, and determines the pre-stored high-frequency configuration parameter, so that the tire pressure sensor can send different types of high-frequency data that can be recognized by the vehicle-mounted ECU. Thus improving the adaptability of tire pressure sensor.

In an embodiment, after step 5302, after performing high-frequency configuration on the tire pressure sensor based on the high-frequency configuration parameter, and storing the high-frequency configuration parameter, the tire pressure monitoring system learning method further includes: sending a first response information to the low-frequency trigger equipment, and the first response information is used to indicate that the high-frequency configuration parameter is successfully configured.

In which, the first response information is a response formed after the tire pressure sensor is successfully configured with high-frequency configuration parameter. The first response information includes a successful response and a failed response.

As an example, when the high-frequency configuration is successful, the first response information is successful response, including SH+len+CMD+XOR. Here, SH is a fixed byte, for example, two bytes 0x66 or 0x6A; Len is the data frame length of the first response information, excluding the fixed byte SH. When CMD is 0xB1, it represents that the command type of low-frequency data is a setting command of high-frequency parameters; XOR is the verification field of the complete frame data of the first response information, which is used to verify whether the first response information is abnormal, excluding SH.

As another example, when the high-frequency configuration is failed, the first response information is failed response, including SH+len+errFlag+CMD+err+XOR.

Here, SH is a fixed byte, for example, two bytes 0x66, 0x6A; Len is the data frame length of the first response information, excluding the fixed byte SH; ErrFlag is fixed byte 0x7F, representing the high-frequency configuration is failed. When CMD is 0xB1, it represents that the command type of low-frequency data is a setting command of high-frequency parameters; Err is configuration error code, including the error reason; XOR is the verification field of the complete frame data of the first response information, which is used to verify whether the first response information is abnormal, excluding SH.

In which, the configuration error code is an error analysis code formed when the configuration of pre-stored high-frequency configuration parameter fails, which is used to analyze the reasons for the failure of configuration of pre-stored high-frequency configuration parameter.

In this embodiment, the tire pressure sensor sends the first response information to the low-frequency trigger equipment, and the first response information is used to indicate that the configuration of high-frequency configuration parameter is successful, so that the low-frequency trigger equipment can timely find out the execution failure of the tire pressure sensor according to the first response information, thus improving the reliability of the tire pressure sensor in the working process.

In an embodiment, after step S40, after generating high-frequency data based on a pre-stored high-frequency configuration parameter and the preset tire pressure data, and sending the high-frequency data to the vehicle-mounted ECU, the tire pressure monitoring system learning method further includes: returning a second response information to the low-frequency trigger equipment, and the second response information is used to indicate that the high-frequency data is successfully sent.

In which, the second response information is a response formed after the high-frequency data is successfully sent. The second response information includes a successful response and a failed response.

As an example, when the high-frequency data is successfully sent, the second response information is successful response, including SH+len+CMD+XOR, where SH is a fixed byte, for example, two bytes 0x66 or 0x6A; Len is the data frame length of the second response information, excluding the fixed byte SH. When CMD is 0B2, it represents that the command type of low-frequency data is a sending command of custom high-frequency data; XOR is the verification field of the complete frame data of the second response information, which is used to verify whether the second response information is abnormal, excluding SH.

As another example, when the high-frequency data is unsuccessfully sent, the second response information is failed response, including SH+len+errFlag+CMD+err+XOR.

Here, SH is a fixed byte, for example, two bytes 0x66, 0x6A; Len is the data frame length of the second response information, excluding the fixed byte SH; ErrFlag is fixed byte 0x7F, representing the transmission of high-frequency data is failed. When CMD is 0B2, it represents that the command type of low-frequency data is a sending command of custom high-frequency data; Err is data transmission error code, including the error reason; XOR is the verification field of the complete frame data of the second response information, which is used to verify whether the second response information is abnormal, excluding SH.

In this embodiment, the tire pressure sensor returns the second response information to the low-frequency trigger equipment, and the second response information is used to indicate that the high-frequency data is successfully sent, so that the low-frequency trigger equipment can timely find out the execution failure of the tire pressure sensor according to the data response information, thus improving the reliability of the tire pressure sensor in the working process.

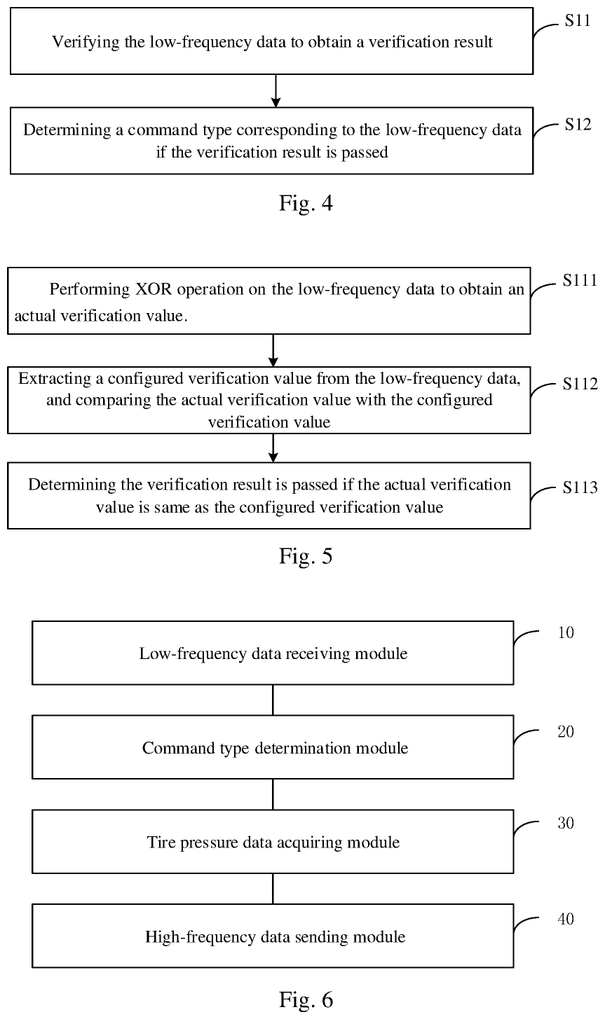

In an embodiment, as shown in FIG. 4, after step S10, prior to determining a command type corresponding to the low-frequency data, the tire pressure monitoring system learning method further includes:

S11: verifying the low-frequency data to obtain a verification result.

In which, the verification result is the result of integrity verification of low-frequency data.

Specifically, because the received low-frequency data may be lost or part of the data may be lost during transmission, in order to improve the accuracy of the subsequent generation of high-frequency data, the tire pressure sensor adopts a preset verification logic to verify the integrity of the low-frequency data and obtain the verification result. Specifically, the preset verification logic may perform XOR Checkout on the low-frequency data, which can quickly verify whether the low-frequency data is complete and improve the verification efficiency.

S12: determining a command type corresponding to the low-frequency data if the verification result is passed.

As an example, when the verification result is that the verification is passed, indicating that the low-frequency data received by the tire pressure sensor is complete data, and then step S20 is executed to determine a command type corresponding to the low-frequency data.

As another example, when the verification result is that the verification fails, indicating that the low-frequency data received by the tire pressure sensor is incomplete data, the low-frequency data will not be processed, and the low-frequency data will be received again.

In this embodiment, the tire pressure sensor verifies the low-frequency data to obtain the verification result. When the verification result is that the verification is passed, the command type corresponding to the low-frequency data is determined. When the verification result is that the verification fails, the low-frequency data will not be processed, and the low-frequency data will be received again, thus improving the reliability of subsequent acquisition of high-frequency data.

In one embodiment, as shown in FIG. 5, in step S101, verifying the low-frequency data to obtain a verification result includes:

S111: performing XOR operation on the low-frequency data to obtain an actual verification value.

In which, the data field is a binary field corresponding to the complete low-frequency data. XOR operation is the operation of XOR logic processing on the low-frequency data. The actual verification value is the value obtained by XOR processing of the low-frequency data.

As an example, the tire pressure sensor performs XOR operation on the complete low-frequency data to obtain the actual verification value.

S112: extracting a configured verification value from the low-frequency data, and comparing the actual verification value with the configured verification value.

In which, the configured verification value is a value corresponding to the verification field in the low-frequency data.

As an example, since the low-frequency data includes a setting command of high-frequency parameters, the tire pressure sensor can extract the verification field and the configured verification value corresponding to the verification field from the setting command of high-frequency parameters in the low-frequency data. Specifically, the step of acquiring a setting command of high-frequency parameters includes Len+CMD+BitWidth+PLLCR_0+PLLCR_1+PLLCR_2+PLLCR_3+count+XOR, in which the configured verification value corresponding to the verification field XOR is extracted, and the actual verification value is compared with the configured verification value.

S113: determining the verification result is passed if the actual verification value is same as the configured verification value.

Specifically, the tire pressure sensor compares the actual verification value with the configured verification value, and when the actual verification value is consistent with the configured verification value, it is determined that the verification is passed; when the actual verification value is inconsistent with the configured verification value, it is determined that the verification fails.

In this embodiment, the tire pressure sensor performs XOR operation on the low-frequency data to obtain the actual verification value. Further, the configured verification value is extracted from the low-frequency data, and the actual verification value is compared with the configured verification value. If the actual verification value is the same as the configured verification value, it is determined that the verification is passed. In this way, the reliability of subsequent acquisition of high-frequency data is improved.

It should be understood that the sequence numbers of the steps in the above embodiments do not indicate the order of execution, and the order of execution of each process should be determined by its function and internal logic, and should not constitute any limitation on the implementation process of the embodiments of the present application.

In an embodiment, a tire pressure monitoring system learning device is provided, which corresponds to the tire pressure monitoring system learning method in the above embodiments. As shown in FIG. 6, the tire pressure monitoring system learning device includes a low-frequency data receiving module 10, a command type determination module 20, a tire pressure data acquiring module 30 and a high-frequency data sending module 40. Detailed description of each functional module is as follows:

a low-frequency data receiving module 10, configured to receive low-frequency data sent by a low-frequency trigger equipment;

a command type determination module 20, configured to determine a command type corresponding to the low-frequency data based on the command type identifier;

a tire pressure data acquisition module 30, configured to acquire a preset tire pressure data in the low-frequency data if the command type is a sending command of custom high-frequency data, and the preset tire pressure data is used for simulating data sent by the tire pressure sensor to a vehicle-mounted ECU in a preset learning scene;

a high-frequency data sending module 40, configured to generate high-frequency data based on a pre-stored high-frequency configuration parameter and the preset tire pressure data, and send the high-frequency data to the vehicle-mounted ECU.

Further, the command type determination module 20 includes:

a data analysis submodule, configured to analyze the low-frequency data to obtain a command type identifier contained in the low-frequency data;

a type identification submodule, configured to determine a command type corresponding to the low-frequency data based on the command type identifier.

Further, the tire pressure monitoring system learning device includes:

a configuration parameter acquisition module, configured to obtain a high-frequency configuration parameter in the low-frequency data if the command type is a setting command of high-frequency parameters;

a high-frequency configuration module, configured to perform high-frequency configuration on the tire pressure sensor based on the high-frequency configuration parameter, and store the high-frequency configuration parameter.

Further, the tire pressure monitoring system learning device includes:

a configuration success module, configured to send a first response information to the low-frequency trigger equipment, and the first response information is used to indicate that the high-frequency configuration parameter is successfully configured.

Further, the tire pressure monitoring system learning device includes:

a sending success module, configured to return a second response information to the low-frequency trigger equipment, and the second response information is used to indicate that the high-frequency data is successfully sent.

Further, the tire pressure monitoring system learning device includes:

a data verification module, configured to verify the low-frequency data to obtain a verification result;

a verification pass module, configured to determine a command type corresponding to the low-frequency data if the verification result is passed.

Further, the data verification module includes:

an XOR submodule, configured to perform XOR operation on the low-frequency data to obtain an actual verification value;

a verification value extraction submodule, configured to extract a configured verification value from the low-frequency data, and compare the actual verification value with the configured verification value;

a verification result submodule, configured to determine the verification result is passed if the actual verification value is same as the configured verification value.

For the specific definitions of the tire pressure monitoring system learning device, please refer to the above descriptions of the tire pressure monitoring system learning method, which will not be repeated here. All the modules in the above-described tire pressure monitoring system learning device may be realized in whole or in part by software, hardware and their combination. The above modules may be embedded in the form of hardware or independent of the processor in the tire pressure sensor, or may be stored in the memory of the tire pressure sensor in the form of software, so that the processor can call and execute the operations corresponding to the above modules.

In one embodiment, a tire pressure sensor is provided, which may be a server, and its internal structure diagram is shown in FIG. 7. The tire pressure sensor includes a processor, a memory, a network interface and a database which are connected through a system bus. And the processor of the tire pressure sensor is used for providing computing and control capabilities. The memory of the tire pressure sensor includes a storage medium and an internal memory. The storage medium stores an operating system, a tire pressure sensing program and a database. The internal memory provides an environment for the operation of the operating system and the tire pressure sensing program in the storage medium. The database of the tire pressure sensor is used for the learning of the tire pressure monitoring system. The network interface of the tire pressure sensor is used to communicate with external terminals through network connection. The tire pressure sensing program is executed by the processor to realize a tire pressure monitoring system learning method.

In one embodiment, a tire pressure sensor is provided, including a memory, a processor, and a tire pressure sensing program stored in the memory and executable on the processor. When the processor executes the tire pressure sensing program, the steps of the tire pressure monitoring system learning method in the above embodiment are realized, such as step S10 to step S40, which will not be repeated here to avoid repetition. Or, when the processor executes the tire pressure sensing program, it realizes the functions of each module/unit of the tire pressure monitoring system learning device in the embodiment. For example, the functions of module 10 to module 40. To avoid repetition, details would not be repeated here.

In one embodiment, a tire pressure monitoring system is provided, as shown in FIG. 8, including a low-frequency trigger equipment, a vehicle-mounted ECU and the tire pressure sensor of the above embodiment, and is used to realize the tire pressure monitoring system learning method of the above embodiment, such as steps S10 to S40, which will not be described in detail here to avoid repetition. Or, it is used to realize the functions of each module/unit of the tire pressure monitoring system learning device in the embodiment. For example, the functions of module 10 to module 40. To avoid repetition, details would not be repeated here.

In an embodiment, a computer-readable storage medium is provided, and a tire pressure sensing program is stored on the computer-readable storage medium. When the tire pressure sensing program is executed by a processor, the tire pressure monitoring system learning method in the above embodiment is realized, such as step S10 to step S40, which will not be described in detail here to avoid repetition. Or, when the tire pressure sensing program is executed by the processor, it realizes the functions of each module/unit of the tire pressure monitoring system learning device in the embodiment. For example, the functions of module 10 to module 40. To avoid repetition, details would not be repeated here.

A person of ordinary skill in the art can understand that all or part of the processes in the method of the foregoing embodiments can be implemented by instructing related hardware through the tire pressure sensing program, which can be stored in a computer-readable storage medium, and the tire pressure sensing program can include the steps of the above method embodiments. Wherein, any reference to memory, storage, database or other medium used in the embodiments provided in this application may include nonvolatile and/or volatile memory. The nonvolatile memory may include read-only memory (ROM), programmable ROM (PROM), electrically programmable ROM (EPROM), electrically erasable programmable ROM (EEPROM), or flash memory. The volatile memory may include random access memory (RAM) or external cache memory. As an illustration and not a limitation, RAM is available in many forms, such as static RAM (SRAM), dynamic RAM (DRAM), synchronous DRAM (SDRAM), double data rate SDRAM (DDRSDRAM), enhanced SDRAM (ESDRAM), synchronous link (Synchlink) DRAM (SLDRAM), memory bus, (Rambus) direct RAM (RDRAM), direct memory bus dynamic RAM (DRDRAM), and memory bus dynamic RAM (RDRAM), etc.

A person of ordinary skill in the art can clearly understand that, for the convenience and conciseness of description, the division of the above functional units and modules are only used examples. In practical applications, the above functions may be implemented by different functional units and modules as needed. That is, the internal structure of the device may be divided into different functional units or modules to complete all or part of the functions described above.

The above embodiments are only used to illustrate the technical solutions of this application, but not to limit it. Although the application has been described in detail with reference to the aforementioned embodiments, those of ordinary skill in the art should understand that the technical solutions described in the aforementioned embodiments may still be modified, or some of the technical features may be equivalently replaced. However, these modifications or substitutions do not make the essence of the technical solutions deviate from the spirit and scope of the technical solutions of each embodiment of this application, and should be included in the protection scope of this application.

1. A tire pressure monitoring system learning method, comprising following steps executed by a tire pressure sensor:
receiving low-frequency data sent by a low-frequency trigger equipment;
determining a command type corresponding to the low-frequency data;
acquiring a preset tire pressure data in the low-frequency data if the command type is a sending command of custom high-frequency data, wherein the preset tire pressure data is used for simulating data sent by the tire pressure sensor to a vehicle-mounted ECU in a preset learning scene;
generating high-frequency data based on a pre-stored high-frequency configuration parameter and the preset tire pressure data, and sending the high-frequency data to the vehicle-mounted ECU.

2. The tire pressure monitoring system learning method of claim 1,
wherein determining a command type corresponding to the low-frequency data comprises:
analyzing the low-frequency data to obtain a command type identifier contained in the low-frequency data;
determining a command type corresponding to the low-frequency data based on the command type identifier.

3. The tire pressure monitoring system learning method of claim 1,
wherein after determining a command type corresponding to the low-frequency data, the tire pressure monitoring system learning method further comprises:
obtaining a high-frequency configuration parameter in the low-frequency data if the command type is a setting command of high-frequency parameters;
performing high-frequency configuration on the tire pressure sensor based on the high-frequency configuration parameter, and storing the high-frequency configuration parameter.

4. The tire pressure monitoring system learning method of claim 3,
wherein after performing high-frequency configuration on the tire pressure sensor based on the high-frequency configuration parameter, and storing the high-frequency configuration parameter, the tire pressure monitoring system learning method further comprises:
sending a first response information to the low-frequency trigger equipment, wherein the first response information is used to indicate that the high-frequency configuration parameter is successfully configured.

5. The tire pressure monitoring system learning method of claim 1, wherein after generating high-frequency data based on a pre-stored high-frequency configuration parameter and the preset tire pressure data, and sending the high-frequency data to the vehicle-mounted ECU, the tire pressure monitoring system learning method further comprises:
returning a second response information to the low-frequency trigger equipment, wherein the second response information is used to indicate that the high-frequency data is successfully sent.

6. The tire pressure monitoring system learning method of claim 1, wherein prior to determining a command type corresponding to the low-frequency data, the tire pressure monitoring system learning method further comprises:
verifying the low-frequency data to obtain a verification result;
determining a command type corresponding to the low-frequency data if the verification result is passed.

7. The tire pressure monitoring system learning method of claim 6, wherein verifying the low-frequency data to obtain a verification result comprises:
performing XOR operation on the low-frequency data to obtain an actual verification value;
extracting a configured verification value from the low-frequency data, and comparing the actual verification value with the configured verification value;
determining the verification result is passed if the actual verification value is same as the configured verification value.

8. A tire pressure monitoring system learning device, comprising:
a low-frequency data receiving module, configured to receive low-frequency data sent by a low-frequency trigger equipment;
a command type determination module, configured to determine a command type corresponding to the low-frequency data based on the command type identifier.
a tire pressure data acquisition module, configured to acquire a preset tire pressure data in the low-frequency data if the command type is a sending command of custom high-frequency data, wherein the preset tire pressure data is used for simulating data sent by the tire pressure sensor to a vehicle-mounted ECU in a preset learning scene;
a high-frequency data sending module, configured to generate high-frequency data based on a pre-stored high-frequency configuration parameter and the preset tire pressure data, and send the high-frequency data to the vehicle-mounted ECU.

9. The tire pressure monitoring system learning device of claim 8,
wherein the command type determination module further comprises:
a data analysis submodule, configured to analyze the low-frequency data to obtain a command type identifier contained in the low-frequency data;
a type identification submodule, configured to determine a command type corresponding to the low-frequency data based on the command type identifier.

10. The tire pressure monitoring system learning device of claim 8, further comprising:
a configuration parameter acquisition module, configured to obtain a high-frequency configuration parameter in the low-frequency data if the command type is a setting command of high-frequency parameters;
a high-frequency configuration module, configured to perform high-frequency configuration on the tire pressure sensor based on the high-frequency configuration parameter, and store the high-frequency configuration parameter.

11. The tire pressure monitoring system learning device of claim 10, further comprising:
a configuration success module, configured to send a first response information to the low-frequency trigger equipment, wherein the first response information is used to indicate that the high-frequency configuration parameter is successfully configured.

12. The tire pressure monitoring system learning device of claim 8, further comprising:
a sending success module, configured to return a second response information to the low-frequency trigger equipment, wherein the second response information is used to indicate that the high-frequency data is successfully sent.

13. The tire pressure monitoring system learning device of claim 8, further comprising:
a data verification module, configured to verify the low-frequency data to obtain a verification result;
a verification pass module, configured to determine a command type corresponding to the low-frequency data if the verification result is passed.

14. The tire pressure monitoring system learning device of claim 13,
wherein the data verification module further comprises:
an XOR submodule, configured to perform XOR operation on the low-frequency data to obtain an actual verification value;
a verification value extraction submodule, configured to extract a configured verification value from the low-frequency data, and compare the actual verification value with the configured verification value;
a verification result submodule, configured to determine the verification result is passed if the actual verification value is same as the configured verification value.

15. A tire pressure sensor, comprising a memory, a processor and a tire pressure sensing program stored in the memory and executable on the processor, wherein the processor executes the tire pressure sensing program to implement following steps:
receiving low-frequency data sent by a low-frequency trigger equipment;
determining a command type corresponding to the low-frequency data;
acquiring a preset tire pressure data in the low-frequency data if the command type is a sending command of custom high-frequency data, wherein the preset tire pressure data is used for simulating data sent by the tire pressure sensor to a vehicle-mounted ECU in a preset learning scene;
generating high-frequency data based on a pre-stored high-frequency configuration parameter and the preset tire pressure data, and sending the high-frequency data to the vehicle-mounted ECU.

16. The tire pressure sensor of claim 15, wherein determining a command type corresponding to the low-frequency data comprises:
analyzing the low-frequency data to obtain a command type identifier contained in the low-frequency data;
determining a command type corresponding to the low-frequency data based on the command type identifier.

17. The tire pressure sensor of claim 15, wherein after determining a command type corresponding to the low-frequency data, the tire pressure sensor further comprises:
obtaining a high-frequency configuration parameter in the low-frequency data if the command type is a setting command of high-frequency parameters;
performing high-frequency configuration on the tire pressure sensor based on the high-frequency configuration parameter, and storing the high-frequency configuration parameter.

18. The tire pressure sensor of claim 17, wherein after performing high-frequency configuration on the tire pressure sensor based on the high-frequency configuration parameter, and storing the high-frequency configuration parameter, the tire pressure sensor further comprises:
sending a first response information to the low-frequency trigger equipment, wherein the first response information is used to indicate that the high-frequency configuration parameter is successfully configured.

19. A tire pressure monitoring system, comprising: a low-frequency trigger equipment, a vehicle-mounted ECU and the tire pressure sensor of claim 15.

20. A computer-readable storage medium, storing a tire pressure sensing program, wherein the tire pressure sensing program, when executed by a processor, realizes the tire pressure monitoring system learning method of claim 1.
